(19) United States
(12) Patent Application Publication
(10) Pub. No.: US 2016/0065588 A1
(43) Pub. Date: Mar. 3, 2016

(54) METHODS AND SYSTEMS FOR DETERMINING COMPLIANCE OF A POLICY ON A TARGET HARDWARE ASSET

(71) Applicant: Thomas Lewis Wheeler, Roanoke, TX (US)

(72) Inventor: Thomas Lewis Wheeler, Roanoke, TX (US)

(73) Assignee: FUSEKICK LLP, Roanoke, TX (US)

(21) Appl. No.: 14/725,696

(22) Filed: May 29, 2015

Related U.S. Application Data
(60) Provisional application No. 62/043,974, filed on Aug. 29, 2014.

(51) Int. Cl. H04L 29/06; G06F 13/40; G06F 13/42

(52) U.S. Cl. CPC H04L 63/107; H04L 63/0435; H04L 63/0485; G06F 13/4282; G06F 13/4072

(57) ABSTRACT

Methods and systems for determining compliance of a policy on a target hardware asset are disclosed. In an embodiment, based on the policy, a command is generated at a host computing device. Subsequently, the command is transmitted to an I/O port of the target hardware asset over a communication channel. Further, a processor of the target hardware asset facilitates execution of the command. Based on the execution, a response may be generated. The response may be analyzed in order to determine compliance of the policy. Further in an embodiment, a priority level of the command may be controlled. The priority level determines allocation of a computing resource for execution of the command. The computing resource may be obtained from a computing resource pool including the processor and at least one virtual computing resource.

### CROSS REFERENCE TO RELATED APPLICATIONS

The present application claims priority to U.S. Provisional Patent Application No. 62/043,974, filed Aug. 29, 2014, entitled “Low-Resource Intensive, Critical Information Scanner with Secure Upload to Cloud Server, for Security Auditing of a Computer Network”, the disclosure of which is incorporated herein by reference in its entirety.

### FIELD OF THE INVENTION

The invention generally relates to the field of Information Technology (IT). More specifically, the invention relates to determining policy compliance of IT equipments.

### BACKGROUND

The use of Information Technology (IT) to facilitate aspects of human activities is widespread. While the use of IT equipment has resulted in several advantages, it brings associated risks. For instance, sensitive information in an IT equipment, if not guarded adequately, may be lost, corrupted or leaked. Accordingly, policies are required to be created and strictly enforced in order to ensure not only safety and integrity of information but also acceptable operation of the IT equipment. Such policies may be defined by one or more of individual users, corporate organizations and government bodies.

However, challenges continue to exist in checking compliance of policies on an IT equipment. For example, one challenge is that existing methods of checking compliance require installation of an auditing software on the IT equipment. The process of installing the auditing software is generally burdensome. For example, in a scenario where there are several IT equipments in an organization, installing the auditing software on each one of them consumes a lot of storage resources and time. Further, in a scenario where a policy on the IT equipment forbids installation of any software other than what already exists, checking compliance is an extremely tedious process, if at all possible.

Another challenge with existing methods of checking compliance is that the usual operation of the IT equipment is disturbed. This is because the auditing software executing on the IT equipment consumes a lot of computing resources. Consequently, other processes executing on the IT equipment suffer from low availability of computing resources. In order to avoid this situation, the auditing software is generally scheduled to be executed during a time when the IT equipment is not being used for its intended purpose. For example, in a corporate organization, the auditing software may be executed during non-business hours, such as at night. However, such time periods may not be available in some situations. Further, it may be required to check compliance of certain policies more frequently.

Accordingly, there is a need for improved methods and systems for checking compliance of IT equipment.

### SUMMARY

Methods of and systems for automatically determining compliance of a policy corresponding to a target hardware asset are disclosed. The target hardware asset includes each of a processor and an Input/Output (I/O) port. In an embodiment, the I/O port may be a Network Interface Controller (NIC) port. In another embodiment, the I/O port may be a Universal Serial Bus (USB) port.

The method includes generating a command at a host computing device which may be communicatively coupled to the target hardware asset. The command may be generated based on the policy. The method further includes transmitting the command to the I/O port of the target hardware asset. The processor facilitates execution of the command. Moreover, each of the generating and the transmitting may be performed automatically.

In an embodiment, the command may be native to an Operating System (OS) corresponding to the target hardware asset.

In an embodiment, the transmitting may be under control of a script executable on a host processor of the host computing device.

In an embodiment, the transmitting may be independent of operation of an input device of the host computing device.

In an embodiment, the command may not be received through an input device of the host computing device.

In an embodiment, the command may not be formed based on operation of an input device of the host computing device.

In an embodiment, the command may be received from a virtual input device of the host computing device.

In an embodiment, the method further includes initiating a remote login session between the host computing device and the target hardware asset. The command may be transmitted within the remote login session. Further, one or more of initiation and termination of the remote login session may not be based on operation of an input device of the host computing device.

In an embodiment, a privilege level corresponding to the command may be identical to a privilege level of a user of the target hardware asset. In another embodiment, a privilege level corresponding to the command may be higher than or lower than a privilege level of a user of the target hardware asset.

In an embodiment, the method may include controlling a priority level corresponding to the command. The priority level determines allocation of at least one computing resource from a computing resource pool for execution of the command. The computing resource pool may include one or more of the processor and at least one virtual computing resource accessible by the target hardware asset.

In an embodiment, the priority level corresponding to the command may be set to lowest level. In another embodiment, allocation of the at least one computing resource may be limited to one or more processors. In a specific embodiment, allocation of the at least one computing resource may be limited to only one processor. In yet another embodiment, allocation of the at least one computing resource may be limited to one or more processing cores. In a specific embodiment, allocation of the at least one computing resource may be limited to only one processing core. In yet another embodiment, the method may further include controlling a priority level corresponding to a sub-process. The command may control execution of the sub-process. Further, the priority level corresponding to the sub-process may be different from the priority level corresponding to the command.

In an embodiment, the method may further include determining one or more of a current resource consumption of at least a portion of the computing resource pool and a predicted resource consumption of least a portion of the computing resource pool. Accordingly, the priority level may be controlled based on one or more of the current resource consumption and the predicted resource consumption.

In an embodiment, the method further includes executing the command utilizing the at least one computing resource. Subsequently, in an embodiment, compliance of the policy may be determined based on a result of executing the command.

In an embodiment, executing the command may include searching at least one of a local storage device and a network storage device for predefined information. Each of the local storage device and the network storage device may be accessible by the target hardware asset. Further, executing the command may also include validating at least part of the predefined information resulting from the searching.

In an embodiment, the method may further include redacting at least a part of the predefined information resulting from the searching to obtain a redacted predefined information. The method may additionally include encrypting one or more of at least a part of the predefined information resulting from the searching and the redacted predefined information to obtain an encrypted predefined information. Further, the method may include transmitting one or more of the redacted predefined information and the encrypted predefined information.

In an embodiment, one or more of the redacted predefined information and the encrypted predefined information may be transmitted to at least one of a cloud server and the host computing device.

In an embodiment, the method may further include analyzing one or more of the redacted predefined information and the encrypted predefined information. The analyzing may be performed in the cloud server.

In an embodiment, the method may further include generating a report based on the analyzing.

### BRIEF DESCRIPTION OF DRAWINGS

FIG. 1 illustrates a method of determining compliance of the policy in accordance with an embodiment.

FIG. 2 illustrates a command processing stack in accordance with an embodiment.

FIG. 3 illustrates steps performed upon execution of the command in accordance with an embodiment.

FIG. 4 illustrates a method of determining compliance of the policy in accordance with another embodiment.

### DETAILED DESCRIPTION

In the following description, numerous specific details are set forth to provide a thorough understanding of the present invention. However, it will be clear to one skilled in the art that the present invention may be practiced without some or all of these specific details. In other instances, well known process steps have not been described in detail in order to avoid unnecessarily obscuring the present invention.

Disclosed herein are methods of and systems for determining compliance of a policy corresponding to a target hardware asset.

In general, the target hardware asset is a physical device that is configured to perform one or more Information Technology (IT) functions such as, but not limited to, processing information, storing information and communicating information. For example, the target hardware asset may be an IT equipment. Examples of the IT equipment include, but are not limited to, personal computer, server computer, network storage device, cloud computer, cloud storage server, thin client, ultra-thin client, mobile computer, smart-phone, local storage device and network device such as router, modem, bridge and relay. The target hardware asset may be implemented using any technology such as, but not limited to, one or more of electronic technology, magnetic technology, optical technology and electro-optical technology.

Further, the target hardware asset includes each of a processor and an Input/Output (I/O) port. The processor in general is any device configured to process information. In some embodiments, the processor may be configured to execute instructions in order to process information. Examples of the processor may be, but are not limited to, a general purpose processor, a special purpose processor and a controller circuit. The controller circuit may be for example, but is not limited to, a memory controller, a storage controller, a system bus controller, Universal Serial Bus (USB) controller, a network controller and a communications controller. The controller circuit may be configured to receive an instruction for performing one or more of a read operation and a write operation. Further, the controller circuit may be configured to return a result of one or more of the read operation and the write operation.

In an embodiment, the target hardware asset may be selected from a set of hardware assets on a network. For instance, a system administrator may select the target hardware asset by specifying a network address, such as an IP address, of the target hardware asset. The selection of the target hardware asset may be performed on an external IT equipment, such as a host computing device. In an embodiment, the target hardware asset may be selected based on a selection criteria provided by a system administrator. Based on the selection criteria, the network may be scanned in order to identify one or more target hardware assets that meet the selection criteria. In another embodiment, the host computing device may function as a central control server for selecting the target hardware asset. In other words, the central control server may enable the system administrator to select one or more of the target hardware asset and the policy. In some embodiments, each of a plurality of host computing devices on the network may function as the central control server.

The I/O port, in general, is a means for communicating information between the target hardware asset and an external IT equipment. The target hardware asset may be configured to communicate with the external IT equipment over a communication channel. In some embodiments, the communication channel may be secured by one or more protocols such as, but not limited to, Transport Layer Security (TLS) and Secure Sockets Layer (SSL) using a dynamic random key. The communication channel may be one or more of a wired communication channel and a wireless communication channel. The I/O port may be one or more of uni-directional and bi-directional. In some embodiments, the I/O port may be configured to only receive information. In some other embodiments, the I/O port may be configured to both receive and send information. The I/O port may be based on any technology according to the technology of the communication channel. Examples, of technologies used to implement the communication channel include, but are not limited to, electromagnetic, optical and acoustical. Further, the technology used to implement the I/O port may also be based on the technology corresponding to one or more components of the target hardware asset in order to enable the one or more components to communicate over the communication channel.

In an embodiment, the I/O port may be a Network Interface Controller (NIC) port. Accordingly, the I/O port enables the one or more components of the target hardware asset to communicate with the external IT equipment over a network. The network may be for example, but is not limited to, a Local Area Network (LAN), a Wide Area Network (WAN), a peer-to-peer network, a Virtual Private Network (VPN), an Intranet and the Internet.

Further, the network may be based on one or more of wired communication technology and wireless communication technology. Examples of wired communication technology include, but are not limited to, switched telephone network and point-to-point wired network. Examples of wireless communication technologies include but are not limited to, cellular wireless technologies, WiMax, WiFi, Bluetooth, Near Field Communications (NFC) and satellite based communications.

In another embodiment, the I/O port may be a Universal Serial Bus (USB) port. Accordingly, the I/O port may enable the one or more components of the target hardware asset to communicate with the external IT equipment according to a serial communication protocol. The external IT equipment may be, for example, a USB storage device.

The policy corresponding to the target hardware asset may, in general, relate to one or more of hardware configuration, software configuration, information stored within the target hardware asset, information accessible to the target hardware asset, operations performable on the target hardware asset, operations performable by the target hardware asset and a context of deployment or use of the target hardware asset. An example of the policy relating to hardware configuration may require the target hardware asset to include a minimum number of processors. An example of the policy relating to software configuration may require that software applications other than that from a pre-defined list should not be installed on the target hardware asset. An example of the policy relating to information stored within the target hardware asset may require pre-defined sensitive information not to be stored on the target hardware asset. An example of the policy relating to information accessible to the target hardware asset may require that pre-defined information residing external to the target hardware asset should not be accessible to the target hardware asset. An example of the policy relating to operations performable on the target hardware asset may require pre-defined information processing operations, such as cryptographic operations, not to be performed on the target hardware asset. An example of the policy relating to operations performable to the target hardware asset may require the target hardware asset to be set in a predefined power state, such as power-off, during a predefined time. An example of the policy relating to the context of deployment or use may require the target hardware asset not to be deployed in predefined geographical locations.

The policy may be defined by one or more of, but not limited to, an individual user of the target hardware asset, an organization using the target hardware asset, a manufacturer of the hardware asset, a consortium of organizations and a governmental regulatory body. For example, the policy may be based on, but is not limited to, PII (Personally Identifiable Information), National Institute of Standards and Technology (NIST) 800-53, Health Insurance Portability and Accountability Act (HIPPA), Sarbanes-Oxley requirements (SOX), Payment Card Industry Data Security Standard (PCI DSS), and Federal Information Security Management Act (FISMA).

Alternatively, the policy may be generated based on one or more other policies corresponding to external IT equipment with which the target hardware asset is configured to communicate. For example, the policy may be inherited from a policy of a client computing device which is configured to access the target hardware asset.

In an embodiment, determining compliance may be binary with a value of “breached” or “not breached”. In another embodiment, determining compliance may be fuzzy with a probability value associated with one or more of “breached” and “not breached”. In yet another embodiment, the determination of compliance may indicate an extent of compliance of the policy, such as a percentage value. Further, determining compliance of the policy may include determining whether the policy has been breached in the past, is currently breached or likely to be breached in the future. Moreover, in some embodiments, determining compliance may include collecting relevant information in relation to the policy from the target hardware asset.

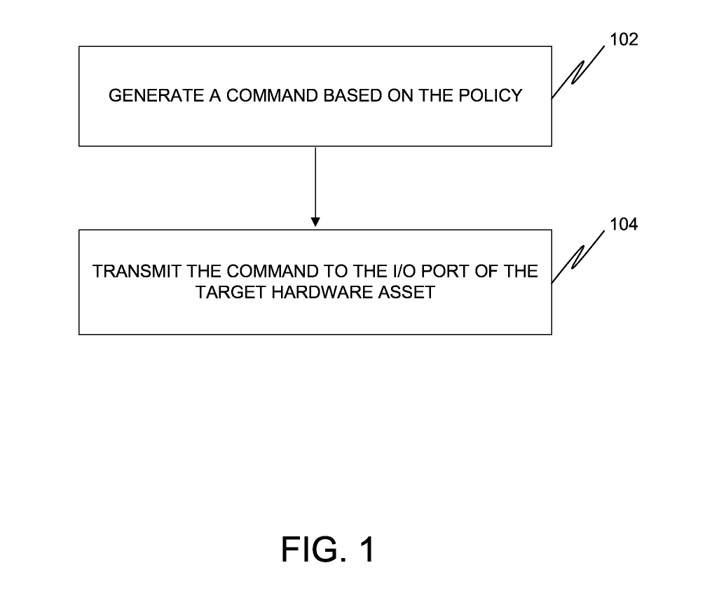

FIG. 1 illustrates a method of determining compliance of the policy in accordance with an embodiment. In order to determine compliance of the policy, at step 102, a command is generated based on the policy. The command may be generated at the external IT equipment, such as a host computing device. The host computing device may include a host processor for facilitating generation of the command. For instance, if the policy relates to presence of predefined sensitive information on the target hardware asset, the command generated may be for performing a search for the predefined sensitive information.

In an embodiment, the generation of the command may be under programmatic control. For instance, a script executable on the host computing device may control generation of the command. In an embodiment, the script may be configured to automatically perform the generation of the command based on predefined rules. For example, based on each of the predefined rules, a set of predefined command primitives and a predefined operation to be performed on the target hardware asset, the script may automatically generate the command.

The pre-defined operation may be based on the policy whose compliance is to be determined. In an embodiment, the generation of the command may additionally be based on characteristics of the target hardware asset. The characteristics may relate to one or more of communication capabilities, hardware capabilities and software capabilities.

Further, in an embodiment, generating the command may involve identifying the command from a set of predefined commands. Further, the identification may be automatically performed by the script. For instance, the script may be configured to identify the command automatically according to a predefined operation to be performed on the target hardware asset. The pre-defined operation may be based on the policy whose compliance is to be determined. For example, the predefined operation may be a search operation for predefined sensitive information. Accordingly, the command may be identified based on the characteristics of the target hardware asset. In an embodiment, the script may access a database of commands in order to identify the command. In another embodiment, the set of predefined commands may be hard-coded into the script.

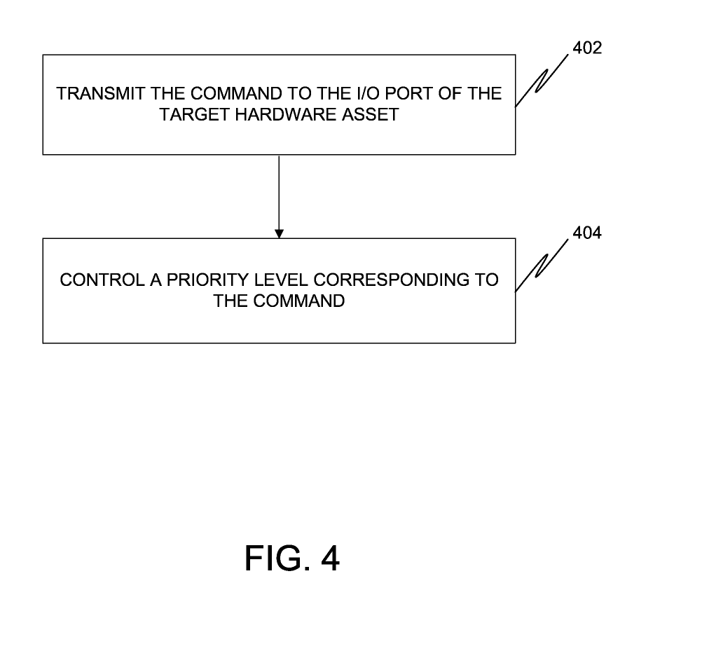

In another instance, the script may be configured to automatically perform modification of the command. In an embodiment, the command may be modified to indicate allocation of computing resources for execution of the command as described in detail in conjunction with FIG. 4.

Subsequently, at step 104, the command is transmitted to the I/O port of the target hardware asset. The command may be transmitted to the I/O port by the external IT equipment over the communication channel. In an embodiment, the external IT equipment may be the host computing device communicatively coupled to the target hardware asset. The host computing device may include a host I/O port for facilitating transmission of the command. The host I/O port may be similar or identical to the I/O port described in detail earlier. As an example, the host computing device may be a server computer connected to the target hardware asset through LAN. In another embodiment, the external IT equipment may be a USB storage device.

The transmission of the command may be initiated by one or more of the target hardware asset and the external IT equipment, such as the host computing device. In an embodiment, the target hardware asset may initiate the transmission of the command regularly according to a predefined schedule. An advantage in this case is that if the target hardware asset is compromised and manipulated not to initiate the transmission, the host computing device may detect the absence of the initiating and raise an alert to a system administrator.

In another embodiment, the target hardware asset may initiate the transmission based on input from a user operating the target hardware asset. For example, the user may notice an abnormal condition on the target hardware asset, such as slower speed of program execution. Accordingly, the user may initiate the transmission by launching a client application program, such as Ping, executing on the target hardware asset. The client application program may be pre-installed on the target hardware asset. Further, in order to initiate the transmission, the client application program may be configured to automatically send a request to a predefined destination address, such as an IP address, corresponding to the host computing device.

In yet another instance, the target hardware asset may initiate the transmission based on occurrence of a predefined condition at the target hardware asset. The predefined condition may be, for example, establishment of a remote access with the target hardware asset from an unauthorized external computing device. Another example of the predefined condition may be anomalous behaviour of an application program executing on the target hardware asset. An advantage of this instance is that the determining of compliance of policy may be performed relatively less frequently and only when there is a high likelihood of occurrence of a breach of the policy. Accordingly, computing resources, which may otherwise have been consumed, may be saved. Yet another example of the predefined condition may be attaching of the USB storage device into the I/O port of the target hardware asset. In this case, the command may be stored at a predetermined location on the target hardware asset. Further, the target hardware asset may be configured to automatically issue a read request for the command stored at the predetermined location.

In another embodiment, the host computing device may initiate the transmission of the command according to one or more of input from a user operating the host computing device and a predefined schedule. For instance, a system administrator operating the host computing device may initiate the transmission of the command by launching a host application program on the host computing device. In this instance, the command may be transmitted by the host application program. In another instance, the host application program may automatically initiate the transmission based on the predefined schedule. An advantage of initiating the transmission of the command from the host computing device is that it offers greater control over when and how frequently the determining of compliance of the policy is performed.

Moreover, in cases where the target hardware asset has been compromised and manipulated not to initiate the transmission of the command, the command may still be transmitted based on initiation by the host computing device.

In an embodiment, each of the initiation of the transmission and transmission of the command may be carried out over a common communication channel. Alternatively, in another embodiment, the initiation of the transmission and the transmission of the command may be carried out on different communication channels. Each of the common communication channel and the different communication channels are instances of the communication channel described earlier.

In an embodiment, the transmission of the command may be controlled by a script executable on the external IT equipment, such as the host computing device. For instance, the script may be executable on a host processor comprised in the host computing device. Accordingly, upon execution of the script, the transmission of the command may take place automatically without any user intervention. In other words, the transmission of the command may be independent of operation of an input device of the host computing device. Further, in some embodiments, the host computing device may not include an input device. The input device is generally any device configured to receive input from a human user to be fed into the host computing device. The input device functions as an interface between the host computing device and a human user. Examples of the input device include, but are not limited to, keyboard, joystick, mouse, touch-screen, touch-pad and gesture recognition device. However, in an embodiment, execution of the script may be initiated by a system administrator operating the host computing device. Alternatively, in another embodiment, the script may be executed automatically based on a predefined schedule. In yet another embodiment, execution of the script may be initiated by a user of the host computing device. In an instance, a privilege level of the user may be lower than that of the system administrator.

In an embodiment, the command may be transmitted to the target hardware asset within a remote access session. The remote access session may be established between the target hardware asset and the external IT equipment, such as the host computing device. As an example, the remote access session may be based on Remote Desktop Protocol (RDP). In an embodiment, prior to transmitting the command, one or more additional commands may be transmitted to the target hardware asset in order to establish the remote access session. Further, one or more of initiation and termination of the remote login session may not be based on operation of an input device of the host computing device. Accordingly, the command may be transmitted over the remote access session without requiring intervention of a system administrator.

In general, in order to determine compliance of the policy, one or more predefined operations may be performed at the target hardware asset. In an embodiment, the command may be transmitted corresponding to each of the one or more predefined operations. Accordingly, multiple commands may be transmitted to the target hardware asset. In another embodiment, the command may perform multiple predefined operations. Further, the one or more predefined operations may depend on the policy whose compliance is to be determined. For instance, if the policy relates to presence of predefined sensitive information, the one or more predefined operations may be search operations. Likewise, if the policy relates to access rights for modifying predefined sensitive information, the one or more predefined operations may be write operations on a file containing the predefined sensitive information.

In an embodiment, the one or more predefined operations on information accessible to the target hardware asset may include one or more of search, validation, de-identification, decoding, encoding, encryption, decryption, compression, decompression, transformation, storage and transmission.

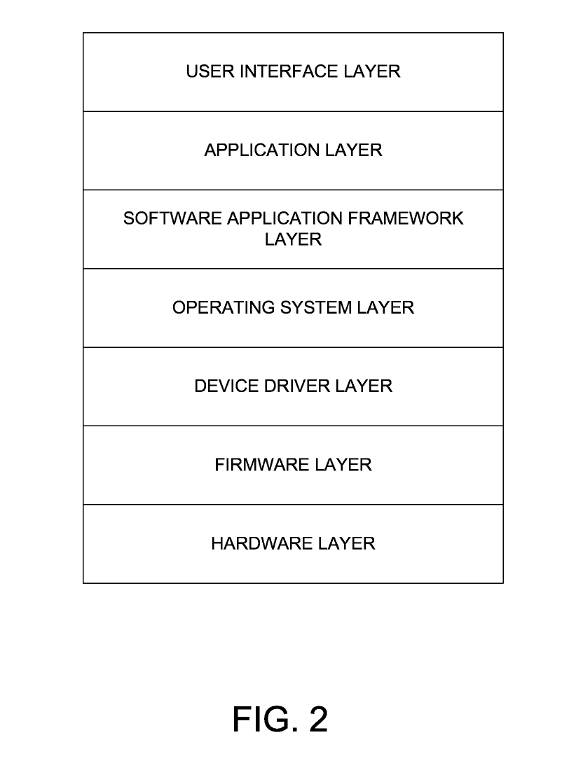

In an embodiment, the command transmitted to the I/O port may correspond to one or more layers of a command processing stack. The command processing stack includes one or more of, but is not limited to, a hardware layer, a firmware layer, device driver layer, an Operating System (OS) layer, a software framework layer, an application layer and a user interface layer. An exemplary illustration of the command processing stack is provided in FIG. 2. The command corresponding to a particular layer of the command processing stack is processed by the particular layer. Accordingly, the form of the command may be such that the corresponding layer is able to recognize and process the command.

As an example, if the command corresponds to the hardware layer, the command may directly interact with the hardware of the target hardware asset. For instance, in an embodiment, the processor may be configured to receive and execute instructions from I/O ports. Accordingly, the command corresponding to the hardware layer may be directly received by the processor for execution. In another instance, the target hardware asset may be a content addressable storage. The content addressable storage may be one or more of volatile and non-volatile. In this case, the command may be a read operation directed to the content addressable storage. Further, the processor is the storage controller that executes the read operation.

As another example, if the command corresponds to the firmware layer, the command may directly invoke firmware routines. For instance, the command may be a read operation for hardware settings that may be retrieved by a firmware routine.

As yet another example, if the command corresponds to the device driver layer, the command may directly invoke functionalities provided by device driver software. Likewise, if the command corresponds to the OS layer, the command may be of a form which is recognizable and executable by an OS of the target hardware asset. In other words, the command may be native to the OS of the target hardware asset. For instance, the command may be a built-in OS command to open a file on the target hardware asset.

As a further example, if the command corresponds to the software application framework layer, the command may directly invoke library functions provided by the software application framework. The software application framework may generally provide an environment for developing software application programs. An example of the software application framework is .NET framework. The library functions included in the software application framework may correspond to one or more of user interface, data access, database connectivity, cryptography, web application development, numeric algorithms, and network communications. Further, the software application framework may provide Application Programming Interfaces (APIs) corresponding to the library functions. In an instance, the command may be an API corresponding to a library function of the library functions. Accordingly, the command may leverage the library functions in order to perform predefined operations for determining compliance of the policy.

As another example, if the command corresponds to the application layer, the command may invoke services of a pre-installed application on the target hardware asset. The pre-installed application may offer greater flexibility since the software application framework and the OS may not have certain functionalities required for determining compliance of the policy. Further, the pre-installed application may include routines which may be optimized for better performance compared to corresponding routines in the OS or the software application framework, if at all available. The pre-installed application may not be present on some hardware assets in a network of hardware assets. Accordingly, in an embodiment, the availability of the pre-installed application may be checked and if available the command may invoke corresponding services. In order to achieve this, in an embodiment, one or more additional commands may be transmitted to the target hardware asset. In another embodiment, the command may include information in order to invoke services of the pre-installed application based on the availability of the pre-installed application on the target hardware asset.

As yet another example, if the command corresponds to the user interface layer, the command may include actions that are usually performed by a human user of the target hardware asset. A user interface may be one or more of, but not limited to, a command line based interface, a graphical user interface (GUI), a voice based interface and a gesture based interface. An instance of the command corresponding to the user interface layer may be to point a mouse cursor to a GUI element of the OS executing on the target hardware asset and subsequently perform a “left-click” operation. In another instance, the command corresponding to the user interface layer may be a textual command, such as a shell command, that is provided to a command line program, such as “cmd.exe” in Windows OS.

In some embodiments, where the command corresponds to the user interface layer, one or more virtual input devices may be instantiated. In order to achieve this, in an embodiment, one or more additional commands may be transmitted to the target hardware asset. In another embodiment, the command may include information in order to instantiate the one or more virtual input devices. For example, a virtual keyboard may be instantiated in the host computing device and the command, such as a shell command, may be transmitted through the virtual keyboard. Further, the one or more virtual input devices may also be instantiated on the target hardware asset. In effect, the use of a virtual input device emulates provision of the command by a human user such as a system administrator. However, the command may not be received through an input device of one or more of the host computing device and the target hardware asset. Further, the command may not be formed based on operation of an input device of one or more of the host computing device and the target hardware asset.

Further in some embodiments, where the command corresponds to the user interface layer, a user interface instance, on which the command operates, may be hidden from view. In order to achieve this, in an embodiment, one or more additional commands may be transmitted to the target hardware asset. In another embodiment, the command may include information in order to control display of the user interface instance. As an example, in case the command corresponds to performing an action on a window of an application program executing on the target hardware asset, the window may be automatically minimized. As another example, the application program may be executed within a virtual desktop which is different from a currently active desktop viewed by the user. As yet another example, the application program may be executed in a “headless” mode. In this mode, display information corresponding to the application program may be routed to a virtual frame-buffer. As a result, in such cases, the user is not disturbed and may thus continue operating the target hardware asset as usual.

In an embodiment, the command may undergo a translation. In an instance, the command may be a high level language command such as a shell command. In this case, the shell command may be translated into a sequence of instructions executable by the processor. The translation may involve one or more of decomposition and consolidation. For instance, the command corresponding to a layer of the command processing stack may be translated into two or more lower-layer instructions. In another instance, two or more commands may be consolidated into one or more instructions, wherein the one or more instructions are fewer in number than the two or more commands.

In some embodiments, the external IT equipment such as the host computing device may be required to authenticate itself to the target hardware asset. For instance, the host computing device may provide an authentication token such as a username and password to the target hardware asset. In a scenario, the authentication token may be provided prior to transmitting the command. In another scenario, the authentication token may be transmitted along with the command. For example, the authentication token may be part of the command. In yet another scenario, the authentication token may be provided after transmitting the command. Based on the authentication token, one or more of acceptance of the command, command execution and transmission of a response of the command execution may be carried out. Accordingly, use of the authentication token provides security to the target hardware asset. In an embodiment, a level of assurance provided by the authentication token may be based on a level of the command processing stack corresponding to the command. For instance, if the command corresponds to the hardware level, a relatively stronger authentication, such as a digital certificate, may be required.

In some other embodiments, the external IT equipment such as the host computing device may not be required to authenticate itself to the target hardware asset. For example, if the communication channel between the target hardware asset and the host computing device is a private and secured, the host computing device inherently possesses a trust level.

Accordingly, the command transmitted by the host computing device may be accepted without authentication.

In an embodiment, the command may be associated with a privilege level. The privilege level generally determines a manner in which the command may be received and processed. For example, the privilege level may determine whether or not the command is executed by the target hardware asset. As another example, the privilege level may determine a scope of execution of the command. For instance, the scope of execution may be limited to certain information residing at the target hardware asset. Accordingly, if the command is for searching for predefined information, the privilege level may limit the search space of the command.

In an embodiment, the privilege level corresponding to the command may be identical to a privilege level of a user of the target hardware asset. Accordingly, the command may be received and executed as if it were issued by the user of the target hardware asset. As a result, determining compliance of the policy in relation to the user may be performed. For instance, the policy may require that a predefined sensitive information should not be accessible to the user. Accordingly, the command may be a search operation for the predefined sensitive information executed with a privilege level identical to that of the user. If the search operation returned the predefined sensitive information, then a breach of the policy may be determined. Similarly if the policy stipulates predefined operations as forbidden to be performed by the user, the command corresponding to the predefined operations may be executed at the privilege level of the user in order to determine compliance of the policy.

In another embodiment, the privilege level corresponding to the command may be higher than a privilege level of a user of the target hardware asset. For instance, the policy may require a predefined sensitive information not to be resident at the target hardware asset. However, a privilege level of the user of the target hardware asset may not entitle accessibility to the predefined sensitive information. In such a scenario, executing the command at a privilege level of the user may not provide a conclusive determination of compliance of the policy. Accordingly, in such cases, the privilege level of the command may be higher than the privilege level of the user. For example, the privilege level may be that of a system administrator or a super-user.

In another embodiment, the privilege level corresponding to the command may be lower than a privilege level of a user of the target hardware asset. For instance, the policy may require a predefined sensitive information resident at the target hardware asset not to be accessible to anyone with a privilege level lower than that of the user. In such a scenario, executing the command at a privilege level of the user may not provide a conclusive determination of compliance of the policy. Accordingly, in such cases, the privilege level of the command may be lower than the privilege level of the user.

In an embodiment, subsequent to transmitting the command, a response may be generated by the target hardware asset based on executing the command. The response may be one or more of an acknowledgement and a result of executing the command. The acknowledgment may indicate to the external IT equipment, such as the host computing device, a status of the command. For example, the status may be one or more of receipt of the command, acceptance of the command, successful execution of the command and failed execution of the command. In an embodiment, the host computing device may determine compliance of the policy based on the acknowledgement. For example, the policy may stipulate that a predefined file resident on the target hardware asset is read-only. Accordingly, the command transmitted may be for performing a write operation on the predefined file. Based on the acknowledgement returned with successful execution of the command, a breach of the policy may be determined.

In another embodiment, the target hardware asset may return the result of executing the command. The result may be returned to the external IT equipment, such as the host computing device. Consider an example where the target hardware asset is a content addressable storage device. Further, the policy may stipulate that the predefined information should not be resident in the content addressable storage device. Accordingly, the command transmitted may be a read operation specifying the predefined information. In this case, the result of executing the command may be one of an address of the predefined information in the content address storage device and a null value. If the result is the null value, it may indicate that the predefined information is not resident in the content addressable storage device. Consequently, compliance of the policy may be determined. On the other hand, if the result returned is the address of the predefined information, it may indicate that the predefined information is resident in the content addressable storage device. Consequently, a breach of the policy may be determined.

In yet another embodiment, the result of executing the command may include the relevant information collected from the target hardware asset. Based on the relevant information, compliance of the policy may be determined. For instance, the relevant information may include information about the software installed on the target hardware asset. Further, the policy may stipulate only a predefine set of allowed software to be installed on the target hardware asset. Accordingly, by comparing the relevant information with the predefined set of allowed software, compliance of the policy may be determined.

In an embodiment, the response may be transmitted to the external IT equipment, such as the host computing device through the I/O port of the target hardware asset. In another embodiment, the repose may be transmitted to the host computing device through another I/O port of the target hardware asset. In yet another embodiment, the response may be transmitted to a cloud server.

In an embodiment, the result transmitted to the external IT equipment, such as the host computing device, may be accessible to a user of the host computing device according to a privilege level of the user. In an instance, a user with a privilege level lower than that of a system administrator may initiate the script responsible for transmitting the command to the target hardware asset. However, the user may not be able to access the result generated by the target hardware asset. As a result, in some embodiments, determining compliance of the policy may be initiated by any user. However, only users with a predefined privilege level may access the result.

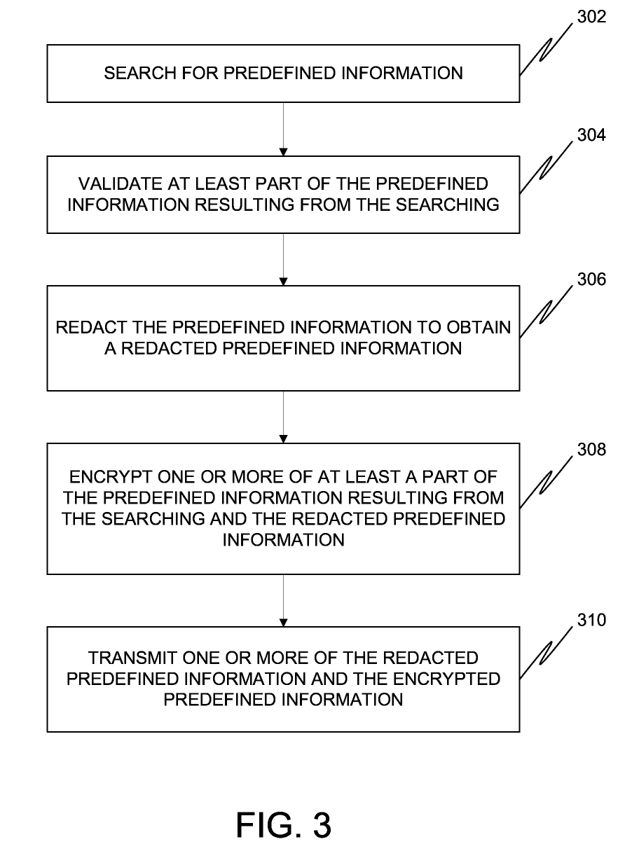

FIG. 3 illustrates a sequence of steps performed upon execution of the command transmitted to the target hardware asset in accordance with an embodiment. At step 302, searching for predefined information is performed upon execution of the command. In an instance, the searching for the predefined information may be performed on one or more of a local storage device and a network storage device. Each of the local storage device and the network storage device may be accessible by the target hardware asset. For example, the local storage device may be contained within the target hardware device while the network storage device may be accessible to the target hardware device over a network. The predefined information may be sensitive information such as, but not limited to, telephone numbers, addresses, credit-card numbers, debit-card numbers, social security numbers, usernames, passwords, decryption keys and financial information. Further, the predefined information may also include user-defined keywords that may be of interest in relation to the policy. The policy may require that the sensitive information not be accessible to the target hardware asset. Accordingly, in order to determine compliance of the policy, the command, upon execution, may search for the sensitive information.

In an instance, the searching may be limited to information in unencrypted form. In another instance, the searching may be performed on encrypted information. Accordingly the encrypted information may first be decrypted using a decryption key. Subsequently, the decrypted information may be searched for the predefined information.

In yet another instance, the searching may be performed based on an index pre-existing on the target hardware asset. An advantage of using the index is that the searching may be performed quickly. In another instance, the searching may be performed by directly reading raw information from one or more of the local storage device and the network storage device.

An advantage of directly reading raw information is that some content which may not have been indexed can also be searched. Further, in case the predefined information has been deliberately hidden by manipulating the index, reading directly from one or more of the local storage device and the network storage device may reveal the presence of the predefined information.

In yet another instance, the searching may be limited to files of predefined file format. Accordingly, the searching may first identify a file with the predefined file format and subsequently search the contents of the file for the predefined information. In a further instance, the searching may be limited to a predefined portion of the files. Alternatively, the searching may be performed on entirety of the files.

In an embodiment, one or more specific algorithms may be used for performing the searching according to the type of the predefined information. For instance, the one or more specific algorithms may identify credit card numbers. Further, a type of credit card number may also be identified.

In an embodiment, as a result of searching, relevant information may be collected. The relevant information may be used to determine compliance of the policy. Additionally, in some embodiments, the relevant information may include environmental information corresponding to the target hardware asset. Examples of relevant information may include one or more of, but is not limited to, OS version, windows license status, kernel version, user access controls status, system creation date, system up-time, system restore status, autoupdate status, software installed on the target hardware asset, time of installation of the software, geographical location where the software was installed, disk location where the software is installed, size of the software installed, patches installed, last time of updation, Windows updates needed, number of people who have logged into the target hardware asset, number of people who have logged into the target hardware asset with admin privileges, number of certificates on the target hardware asset, types/issuers of the certificates, presence of AV system, number of WiFi Service Set Identifier (SSIDs) stored in memory, WiFi SIDs which are stored in memory, number of USBs IDs stored in registry, name of USBs IDs stored in registry, RAM, total number of disks, number of local disks, number of network disks, free space, sizes of hard drives, shares folders on the target hardware asset, firewall status, browser proxy use status, IDs of open ports (active connections) and TCP/UDP ports. Further, at step 304, validating at least part of the predefined information resulting from the searching may be performed. Validation of at least part of the predefined information is required in order to avoid false positives. For example, the searching for sensitive information may have resulted in a number that is of the same form as that of credit card numbers. However, the number may be a serial number for a software application license and not a valid credit card number. Accordingly, validation of information resulting from the searching may be needed in some cases to establish that the information is indeed the predefined information.

In an embodiment, validating may be selectively performed based on predefined rules. For instance, a predefined rule may stipulate validating to be performed in case a form of the predefined information is similar or identical across different kinds of information. In other words, when two or more different kinds of information have the same or similar form, then validating may be performed. For example, credit card numbers and some software license are of the same form. Another predefined rule may stipulate validating to be performed in case only a subset of all possible values of the predefined information is valid. For example, only a subset of all 16 digit number combinations is valid as a credit card number. Accordingly, a validation algorithm, such as Luhn's algorithm may be used to validate information resulting from the searching. In another embodiment, Luhn's algorithm may be used to validate information such as credit card numbers identified by the one or more specific algorithms. In an embodiment, validating may be performed locally on the target hardware asset. For instance, a validating function may be part of an OS executing on the target hardware asset. Accordingly, the validating function may be invoked by the command. As a result, confidential information such as financial information remains within the target hardware asset in some embodiments. In another embodiment, validating may be performed remotely on a server. At least part of the predefined information resulting from the searching may be transmitted to the server. Subsequently, the server may perform the validating and return a response indicating validity. For example, for validating social security numbers, a corresponding U.S. government website may be queried.

Thereafter, at step 306, the predefined information resulting from the searching may be redacted to obtain a redacted predefined information. In another embodiment, the predefined information which has been validated may be redacted. Redacting the predefined information involves transforming the predefined information in order to render the predefined information unusable for its intended purposes. For instance, some digits of a credit-card number may be replaced by an asterisk symbol. In another instance, redacting may involve de-identifying the predefined information. As a result, although the form of the predefined information may be maintained, it may not be possible to associate the predefined information with a particular individual. For example, certain digits of a social security number may be manipulated according to a rule in order to result in an invalid social security number.

In an embodiment, redacting may be performed locally on the target hardware asset. For instance, a redacting function may be part of an OS executing on the target hardware asset. Accordingly, the redacting function may be invoked by the command. As a result, confidential information such as financial information remains within the target hardware asset in some embodiments. In another embodiment, redacting may be performed remotely on a server. Accordingly, at least part of the predefined information resulting from the searching may be transmitted to the server. In another embodiment, the predefined information which has been validated may be transmitted to the server. Subsequently, the server may perform the redacting. In some embodiments, the server may return the redacted predefined information to the target hardware asset.

Subsequently, at step 308, one or more of at least a part of the predefined information resulting from the searching and the redacted predefined information may be encrypted to obtain an encrypted predefined information. One or more of symmetric and asymmetric encryption techniques may be used to obtain the encrypted predefined information. In an embodiment, a library function provided by the software application framework, such as .NET, may be invoked to perform the encryption. By performing encryption, greater security is provided to the predefined information. Further, in some embodiments, one or more of at least a part of the predefined information resulting from the searching and the redacted predefined information may be de-duplicated.

In an embodiment, one or more of at least a part of the predefined information resulting from the searching and the redacted predefined information may be stored in a password protected file. For example, the password protected file may be an encrypted Microsoft Excel file locked with a 20 character, complex password. The Microsoft Excel file may further be encrypted with an AES 256 encryption key to yield an encrypted password protected file.

Thereafter, at step 310, one or more of the redacted predefined information and the encrypted predefined information may be transmitted to an external IT equipment. In an instance, the encrypted password protected file may be transmitted to the external IT equipment.

In an embodiment, the external IT equipment may be a cloud server. For instance, an encrypted bucket located in the cloud server may be used to store one or more of the redacted predefined information and the encrypted predefined information. In another instance, the cloud server may include an SQL database in order to store one or more of the redacted predefined information and the encrypted predefined information.

In another embodiment, the external IT equipment may be the host computing device that transmitted the command. Further, in an embodiment, the host computing device may relay the encrypted information to the cloud server.

In yet another embodiment, the external IT equipment may be another host computing device in communication with the target hardware asset.

Transmission of the encrypted information may take place over the communication channel utilizing a secure encryption based protocol in order to provide further security. As a result of this multi-layered encryption, gaining unauthorized access to the predefined information becomes virtually impossible. Accordingly, one or more of the redacted predefined information and the encrypted predefined information stored in the cloud server may be accessible only to authorized individuals.

In an embodiment, the encrypted predefined information may be decrypted at the external IT equipment, such as the cloud server. Subsequently, one or more of the decrypted predefined information and the redacted predefined information may be subjected to analysis. Thereafter, an auditing report may be generated based on the analysis. An advantage of this embodiment is that any authorized user, such as an auditor, may access the cloud server from any computer and perform one or more of the analysis and viewing of the report. Further, the cloud server may allow the auditor to control the analysis by enabling the auditor to select one or more of, information to be subjected to the analysis and a type of the analysis. Accordingly, greater flexibility in performing auditing is provided.

FIG. 4 illustrates a method of determining compliance of the policy in accordance with another embodiment. At step 402, the command based on the policy is transmitted to the I/O port of the target hardware asset. The transmission of the command is explained in detail in conjunction with FIG. 1. At step 404, a priority level corresponding to the command may be controlled. The priority level may determine allocation of at least one computing resource for execution of the command. The at least one computing resource may be allocated from a computing resource pool. The at least one computing resource may be one or more of a hardware computing resource and a software computing resource. Examples of hardware computing resources include, but are not limited to, processors, memory, non-volatile storage and I/O ports. Examples of software computing resources include, but are not limited to, threads, positions in queues, locks, sockets and file handles.

In an embodiment, the computing resource pool may include the processor of the target hardware asset. Accordingly, the command may be executed by the processor. In another embodiment, the computing resource pool may include a virtual computing resource accessible by the target hardware asset. For example, in case the target hardware asset is a thin-client, the processor may facilitate execution of the command by forwarding the command to a cloud server providing services to the thin-client. Accordingly, the command may be executed by the cloud server.

In an embodiment, the priority level corresponding to the command may be set to lowest level. Accordingly, an amount of computing resources allocated for execution of the command may be low. In an instance, this may be achieved by setting a priority level of a thread corresponding to the command. For example, in Windows OS, the thread may be set to the lowest priority level just above IDLE. Further in another instance, the number of processors allocated for execution of the command may be limited to one. In another instance, the amount of computing resources allocated for execution of the command may be limited to only one processing core. Accordingly, execution of the command consumes minimum computing resources of the target hardware asset. As a result, other processes executing on the target hardware asset may not be deprived of computing resources.

In another embodiment, the number of processors allocated for execution of the command may be limited to one or more processors. Further, the amount of computing resources allocated for execution of the command may be limited to one or more processing cores. Accordingly, greater flexibility is provided in controlling allocation of the at least one computing resource for execution of the command.

In an embodiment, controlling the priority level may be performed prior to transmitting the command. For example, the command may first be formed with information indicating the priority level. Subsequently, the command may be transmitted. In another embodiment, controlling the priority level may be performed subsequent to transmitting the command. For example, subsequent to transmitting the command, an additional command may be transmitted to the target hardware asset in order to effect the controlling of the priority level of the command transmitted earlier.

In an embodiment, the command may control a sub-process, for example, by invoking the sub-process. In an embodiment, the sub-process may perform the one or more predefined operations corresponding to the command. For example, the sub-process may be a thread that searches for the predefined information resident in the target hardware asset. Another example of the sub-process may be a thread for encrypting the predefined information resulting from the searching. Further, a priority level corresponding to the sub-process may be controlled. Accordingly, based on the priority level corresponding to the sub-process, allocation of computing resources for execution of the sub-process may be performed. As a result, a fine degree of control may be exercised in managing consumption of computing resources for executing one or more of the command and the sub-process.

In an instance, the priority level corresponding to the sub-process may be based on the priority level of the command. For example, the sub-process may derive the priority level from the command. In another instance, the priority level corresponding to the sub-process may be different from the priority level of the command. For instance, the priority level of the command may be HIGH in order to enable early execution of the command and invocation of the sub-process, such as encryption. However, the priority level of the sub-process, may be LOW. In this case, the sub-process is a compute intensive process. Therefore, by setting the priority level of the sub-process to LOW, consumption of computing resources may be minimized.

In an embodiment, one or more of the priority level corresponding to the command and the priority level corresponding to the sub-process may be controlled by transmitting one or more additional commands. In another embodiment, the command may include priority level indicators for one or more of the command and the sub-process in the form of FLAGs.

In an embodiment, one or more of the priority level of the command and the priority level of the sub-process may be based on one or more of a current resource consumption of at least a portion of the computing resource pool and a predicted resource consumption of least a portion of the computing resource pool. Accordingly, one or more of the current resource consumption and the predicted resource consumption may be determined. In an embodiment, in order to determine one or more of the current resource consumption and the predicted resource consumption, one or more additional commands may be transmitted. The current resource consumption may indicate an amount of available computing resources. Therefore, by controlling the priority level of the command based on the amount of available computing resources, better management of computing resources may be achieved. Similarly, the predicted resource consumption may indicate a future need of computing resources by other processes executing on the processor of the target hardware asset. The predicted resource consumption may be determined based on, for example, analysis of historical resource consumption data of one or more other processes executing on the processor.

Subsequently, upon execution of the command, a determination of compliance of the policy may be performed as described in detail in conjunction with FIG. 1, FIG. 2 and FIG. 3.

Further disclosed herein is a non-transitory computer readable medium for determining compliance of the policy corresponding to the target hardware asset. The target hardware asset includes each of the processor and the Input/Output (I/O) port. Further, the non-transitory computer readable medium includes program code recorded thereon such that when placed in communicable contact with the host processor of the external IT equipment, such as the host computing device, the host processor transmits the command to the I/O port. Subsequently, execution of the command may be facilitated by the processor of the target hardware asset. Further, the host processor controls the priority level corresponding to the command. The priority level determines allocation of the at least one computing resource from the computing resource pool for execution of the command. The computing resource pool includes one or more of the processor and the at least one virtual computing resource accessible by the target hardware asset. Additionally, in some embodiments, the host processor may perform the generation of the command. Details about the generation of the command, the controlling of the priority level and the transmission of the command are explained in conjunction with FIG. 1 and FIG. 2.

Additionally a system for determining compliance of the policy is disclosed. The system may include the host processor and the host I/O port. Further, the system may be configured to perform one or more of generating the command, controlling the priority level of the command and transmitting the command as explained in detail in conjunction with FIG. 1, FIG. 2, FIG. 3 and FIG. 4.

Methods, systems and non-transitory computer readable medium disclosed herein for determining compliance of the policy provide several advantages in various embodiments. One advantage is that installation of an auditing software on the target hardware asset is not required. Accordingly, storage space on the target hardware asset is conserved. Further, a burden of installing the auditing software is eliminated. Moreover, determination of compliance is possible even in cases where the target hardware asset may forbid installation of any additional software, such as the auditing software. Another advantage is that by controlling an amount of computing resources allocated for executing the command, a computational burden on the target hardware asset may be minimized Consequently, other processes executing on the target hardware asset may not suffer from reduced availability of computing resources. As a result, the methods of determining compliance may be performed even during business hours, without affecting the experience of a user operating the target hardware asset.

The described techniques may be implemented as a method, apparatus or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed. Certain embodiments can take the form of an entirely hardware embodiment, an entirely software embodiment or an embodiment containing both hardware and software elements. In an embodiment, the invention may be implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Furthermore, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

While the present invention has been described in the foregoing embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadcast interpretation so as to encompass all such modifications and equivalent structures and functions.

We claim:

1. A method of determining compliance of a policy corresponding to a target hardware asset, the target hardware asset comprising a processor and an Input/Output (I/O) port, the method comprising:
a. transmitting a command to the I/O port, wherein the processor facilitates execution of the command; and
b. controlling a priority level corresponding to the command, wherein the priority level determines allocation of at least one computing resource from a computing resource pool for execution of the command, wherein the computing resource pool comprises at least one of the processor and at least one virtual computing resource accessible by the target hardware asset.

2. The method of claim 1, wherein the priority level corresponding to the command is set to lowest level.

3. The method of claim 1, wherein allocation of the at least one computing resource is limited to one or more processors.

4. The method of claim 1 further comprising controlling a priority level corresponding to a sub-process, wherein the command controls execution of the sub-process, wherein the priority level corresponding to the sub-process is different from the priority level corresponding to the command.

5. The method of claim 1 further comprising:
a. determining one or more of a current resource consumption of at least a portion of the computing resource pool and a predicted resource consumption of least a portion of the computing resource pool; and
b. controlling the priority level based on one or more of the current resource consumption and the predicted resource consumption.

6. The method of claim 1, wherein the I/O port is a Network Interface Controller (NIC) port.

7. The method of claim 1, wherein the I/O port is a Universal Serial Bus (USB) port.

8. The method of claim 1, wherein the command is native to an Operating System (OS) corresponding to the target hardware asset.

9. The method of claim 1 further comprising:
a. executing the command utilizing the at least one computing resource; and
b. determining compliance of the policy based on a result of executing the command.

10. The method of claim 9, wherein executing the command comprises:
a. searching at least one of a local storage device and a network storage device for predefined information, wherein each of the local storage device and the network storage device is accessible by the target hardware asset; and
b. validating at least part of the predefined information resulting from the searching.

11. The method of claim 10 further comprising:
a. redacting at least a part of the predefined information resulting from the searching to obtain a redacted predefined information;
b. encrypting one or more of at least a part of the predefined information resulting from the searching and the redacted predefined information to obtain an encrypted predefined information; and
c. transmitting one or more of the redacted predefined information and the encrypted predefined information.

12. The method of claim 11, wherein one or more of the redacted predefined information and the encrypted predefined information are transmitted to at least one of a cloud server and a host computing device.

13. The method of claim 11 further comprising analyzing one or more of the redacted predefined information and the encrypted predefined information, wherein the analyzing is performed in the cloud server.

14. The method of claim 13 further comprising generating a report based on the analyzing.

15. The method of claim 1, wherein a privilege level corresponding to the command is identical to a privilege level of a user of the target hardware asset.

16. The method of claim 1, wherein a privilege level corresponding to the command is one of higher than and lower than a privilege level of a user of the target hardware asset.

17. A non-transitory computer readable medium for determining compliance of a policy corresponding to a target hardware asset, the target hardware asset comprising a processor and an Input/Output (I/O) port, the non-transitory computer readable medium having program code recorded thereon such that when placed in communicable contact with a host processor of a host computing device, the host processor performs the steps of:
a. transmitting a command to the I/O port, wherein the processor facilitates execution of the command; and
b. controlling a priority level corresponding to the command, wherein the priority level determines allocation of at least one computing resource from a computing resource pool for execution of the command, wherein the computing resource pool comprises at least one of the processor and at least one virtual computing resource accessible by the target hardware asset.

18. The non-transitory computer readable medium of claim 17, wherein the priority level corresponding to the command is set to lowest level.

19. The non-transitory computer readable medium of claim 17, wherein allocation of the at least one computing resource is limited to one or more processors.

20. The non-transitory computer readable medium of claim 17 further comprising program code for controlling a priority level corresponding to a sub-process, wherein the command controls execution of the sub-process, wherein the priority level corresponding to the sub-process is different from the priority level corresponding to the command.

21. The non-transitory computer readable medium of claim 17 further comprising program code for:
a. determining one or more of a current resource consumption of at least a portion of the computing resource pool and a predicted resource consumption of least a portion of the computing resource pool; and
b. controlling the priority level based on one or more of the current resource consumption and the predicted resource consumption.

22. The non-transitory computer readable medium of claim 17, wherein the I/O port is a Network Interface Controller (NIC) port.

23. The non-transitory computer readable medium of claim 17, wherein the I/O port is a Universal Serial Bus (USB) port.

24. The non-transitory computer readable medium of claim 17, wherein the command is native to an Operating System (OS) corresponding to the target hardware asset.

25. The non-transitory computer readable medium of claim 17 further comprising program code for:
a. executing the command utilizing the at least one computing resource; and
b. determining compliance of the policy based on a result of executing the command.

26. The non-transitory computer readable medium of claim 25 further comprising program code for:
a. searching at least one of a local storage device and a network storage device for predefined information, wherein each of the local storage device and the network storage device is accessible by the target hardware asset; and
b. validating at least part of the predefined information resulting from the searching.

27. The non-transitory computer readable medium of claim 26 further comprising program code for:
a. redacting at least a part of the predefined information resulting from the searching to obtain a redacted predefined information;
b. encrypting one or more of at least a part of the predefined information resulting from the searching and the redacted predefined information to obtain an encrypted predefined information; and
c. transmitting one or more of the redacted predefined information and the encrypted predefined information.

28. The non-transitory computer readable medium of claim 27, wherein one or more of the redacted predefined information and the encrypted predefined information are transmitted to at least one of a cloud server and the host computing device.

29. The non-transitory computer readable medium of claim 27 further comprising program code for analyzing one or more of the redacted predefined information and the encrypted predefined information, wherein the analyzing is performed in the cloud server.

30. The non-transitory computer readable medium of claim 27 further comprising program code for generating a report based on the analyzing.

31. The non-transitory computer readable medium of claim 17, wherein a privilege level corresponding to the command is identical to a privilege level of a user of the target hardware asset.

32. The non-transitory computer readable medium of claim 17, wherein a privilege level corresponding to the command is one of higher than and lower than a privilege level of a user of the target hardware asset.

33. A method of automatically determining compliance of a policy corresponding to a target hardware asset, the target hardware asset comprising a processor and an Input/Output (I/O) port, the method comprising:
a. generating a command at a host computing device communicatively coupled to the target hardware asset, wherein the command is based on the policy; and
b. transmitting the command to the I/O port of the target hardware asset, wherein the processor facilitates execution of the command, wherein each of the generating and the transmitting is performed automatically.

34. The method of claim 33, wherein the transmitting is under control of a script executable on the host processor.

35. The method of claim 33, wherein the transmitting is independent of operation of an input device of the host computing device.

36. The method of claim 33, wherein the command is not received through an input device of the host computing device.

37. The method of claim 33, wherein the command is not formed based on operation of an input device of the host computing device.

38. The method of claim 33, wherein the command is received from a virtual input device of the host computing device.

39. The method of claim 33 further comprising initiating a remote login session between the host computing device and the target hardware asset, wherein the command is transmitted within the remote login session.

40. The method of claim 39, wherein one or more of initiation and termination of the remote login session is not based on operation of an input device of the host computing device.
